(19) United States
(12) Patent Application Publication
(10) Pub. No.: US 2022/0385803 A1
(43) Pub. Date: Dec. 1, 2022

(54) IMAGE DATA ACQUISITION DEVICE AND IMAGE ANNOTATION METHOD FOR UNMANNED VENDING MACHINE

(71) Applicant: Harbin Institute of Technology, Shenzhen, Shenzhen (CN)

(72) Inventors: Haijun ZHANG, Shenzhen (CN); Haibin ZHOU, Shenzhen (CN); Dingding ZUO, Shenzhen (CN)

(21) Appl. No.: 17/824,947

(22) Filed: May 26, 2022

(30) Foreign Application Priority Data
May 26, 2021 (CN) 202110578350.6

(51) Int. Cl. H04N 5/232; H04N 5/225; G06V 10/26; G06V 10/764

(52) U.S. Cl. CPC H04N 5/23218; H04N 5/23299; H04N 5/2256; G06V 10/26; G06V 10/764

(57) ABSTRACT

An image data acquisition device includes a camera, an elevating system, and a control processor. The camera covers a photographing scene, and is configured to capture images of a plurality of objects in the photographing scene. The elevating system is connected to the camera and moves the plurality of objects in and out of the photographing scene, and moves the plurality of objects in the photographing scene to meet a preset placement condition. The control processor is configured to control the elevating system to move the plurality of objects in the photographing scene in a preset order to meet the preset placement condition, to control the camera to capture an image of the plurality of objects meeting the preset placement condition, and to label the image of the plurality of objects through image annotation.

### CROSS-REFERENCE TO RELATED APPLICATIONS

Pursuant to 35 U.S.C. § 119 and the Paris Convention Treaty, this application claims foreign priority to Chinese Patent Application No. 202110578350.6 filed May 26, 2021, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of image acquisition, and more particularly, to an image data acquisition device and an image annotation method for an unmanned vending machine.

Computer vision technology for an unmanned vending machine relies on a powerful database. Conventionally, an image data acquisition process includes: 1) manually moving beverages in or out of an unmanned vending machine; 2) capturing two top images showing changes of locations and types of the beverages before and after a product is removed from the unmanned vending machine; and 3) manually annotating the types and number of the products in the two images. The conventional data acquisition process is tedious, inefficient, time consuming, thus increasing labor cost.

### SUMMARY

To solve the aforesaid problems, the disclosure provides an image data acquisition device for an unmanned vending machine; the image data acquisition device is designed to simulate the process of moving products into or out of the unmanned vending machine, acquire images from cameras, and create an image database.

The image data acquisition device comprises a camera, an elevating system, and a control processor. The camera covers a photographing scene, and is configured to capture images of a plurality of objects in the photographing scene. The elevating system is connected to the camera and moves the plurality of objects in and out of the photographing scene, and moves the plurality of objects in the photographing scene to meet a preset placement condition. The preset placement condition refers to a position combination of the plurality of objects in the photographing scene. The control processor is configured to control the elevating system to move the plurality of objects in the photographing scene in a preset order to meet the preset placement condition, to control the camera to capture an image of the plurality of objects meeting the preset placement condition, and to label the image of the plurality of objects through image annotation.

In a class embodiment of the disclosure, the elevating system comprises a base and at least one elevator; and the at least one elevator comprises a transmission part and a support bracket. The support bracket is fixedly disposed on the base; and the transmission part is fixedly disposed on the base and the support bracket. The transmission part comprises a motor, a threaded rod, a directional rod, and a transmission bracket. The directional rod is fixedly disposed on the base and the support bracket, and is configured to control one of the plurality of objects to move along an axial direction; the axial direction is an extension direction of the directional rod. The threaded rod is disposed along the axial direction; one end of the threaded rod is connected to the motor; and another end of the threaded rod is fixedly connected to the support bracket. The transmission bracket is in a threaded connection to the threaded rod. The transmission bracket is slidably connected to the directional rod; and one of the plurality of objects is detachably fixed on the transmission bracket.

In a class embodiment of the disclosure, the elevating system comprises a plurality of elevators each comprising a transmission part for carrying one of the plurality of objects.

In a class embodiment of the disclosure, the camera comprises a camera lens, a camera bracket, and a backdrop board. The camera lens is disposed on the camera bracket; the backdrop board provides a background used to take a picture and is at least one in number; the backdrop board is connected to the elevating system and comprises at least one through hole; and the elevating system drives the plurality of objects to pass through the at least one through hole.

In a class embodiment of the disclosure, the backdrop board comprises at least one cover.

In a class embodiment of the disclosure, the at least one cover is horizontally connected to the backdrop board through a hinge, and is foldable relative to the backdrop board towards the photographing scene.

In a class embodiment of the disclosure, the backdrop board is flat and level with the ground, and a maximum included angle between the backdrop board and the at least one cover is not greater than 90 degrees.

In a class embodiment of the disclosure, the camera lens is disposed above the photographing scene to capture a top image of the plurality of objects in the photographing scene.

In a class embodiment of the disclosure, the camera further comprises a light source controlled by the control processor.

The disclosure further comprises an image annotation method for use in the image data acquisition device of the disclosure, the image annotation method comprising:
manually labeling a first bounding box around each object in a part of first images;
training a model for a one-class object detection by using the first bounding box around each object in the number of the first images, to label a second bounding box around each object in remaining first images;
labeling the second bounding box around each object in the remaining first images by using the model, thus obtaining second images;
naming each object in a part of the second images according to a location of the second bounding box for each object in the part of the second image and the preset order controlled by the image data acquisition device; and
training a binary classification algorithm over the first bounding box and name of each object in the part of the first images, to name the second bounding boxes in the remaining second images, thus creating an annotation file.

The following advantages are associated with the image data acquisition device and the image annotation method thereof:

1. The image data acquisition device simulates the process of moving objects into or out of the unmanned vending machine, and controls automatic image acquisition, which is time saving and reduces labor cost, thus improving the image acquisition efficiency. About five images are captured every minute in manual mode of conventional methods, which is a labor-intensive and error-prone process; and the image data acquisition device captures ten images per minute without losing quality.

2. Automatic annotation is used in conjunction with manual annotation to improve the efficiency and accuracy of image data annotation. A small number of the first images are manually annotated and used to train a binary classification model for differentiation of the second bounding boxes in the remaining second images; the binary classification model is trained over the location and preset order of each object in the first images captured by the image data acquisition device, and annotates each object in the remaining second images to create an annotation file; and the annotation file is verified manually; about five images are annotated manually every minute; and the image annotation method of the disclosure labels and verifies 50 images every minute, which is 10 times faster than the manual annotation.

### DETAILED DESCRIPTION OF THE DRAWINGS

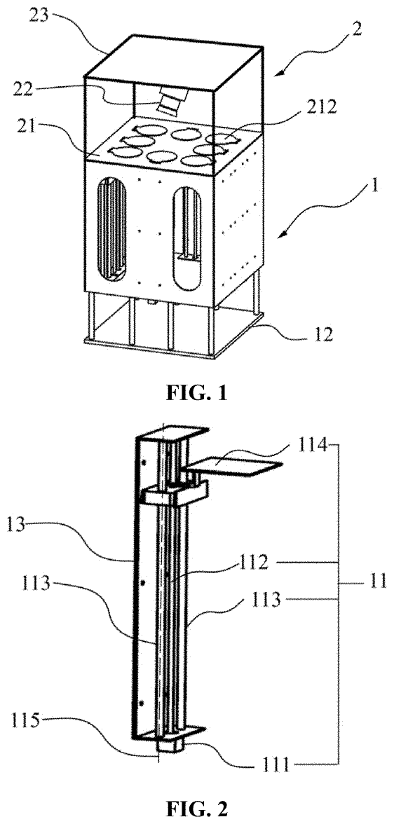

FIG. 1 is a perspective view of an image data acquisition device according to one example of the disclosure;

FIG. 2 is a perspective view of a transmission part and a support bracket according to one example of the disclosure;

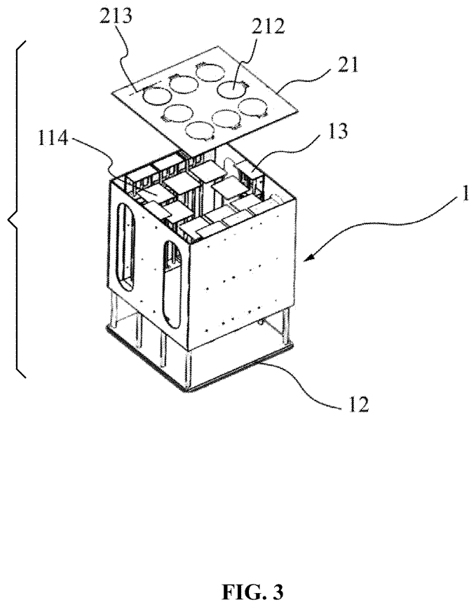

FIG. 3 is an exploded view of an image data acquisition device according to one example of the disclosure;

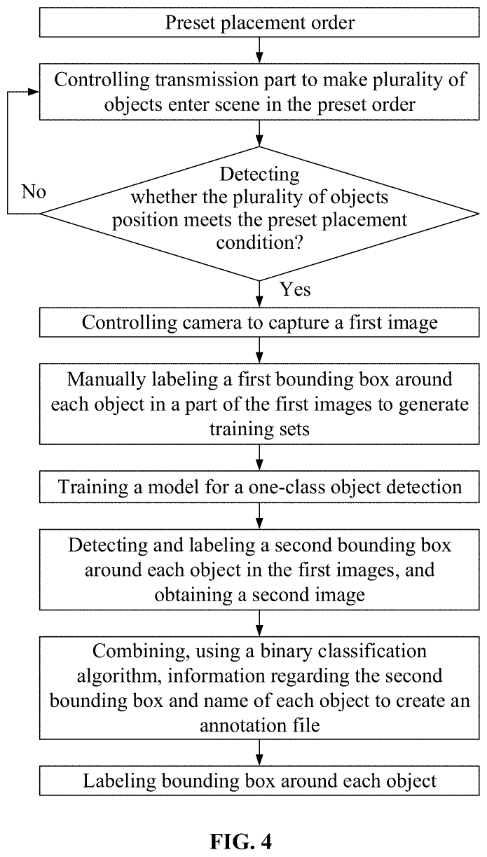

FIG. 4 is a control-flow diagram of a control processor according to one example of the disclosure;

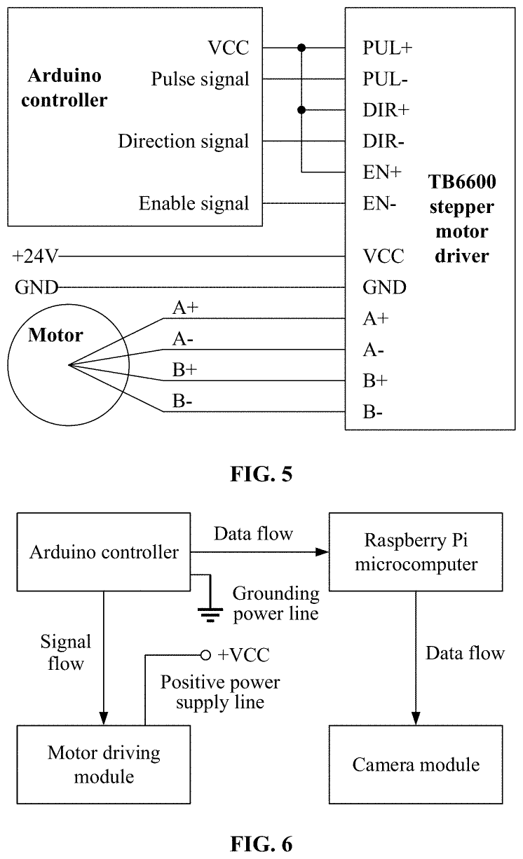

FIG. 5 is a circuit diagram of a motor according to one example of the disclosure;

FIG. 6 is a block diagram of four function modules according to one example of the disclosure; and

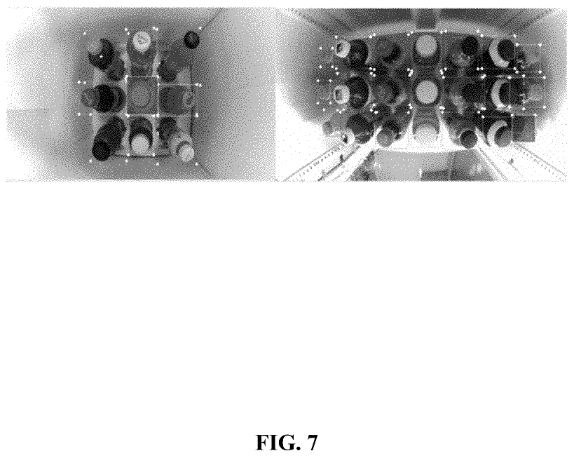

FIG. 7 is a second image comparison between an image data acquisition device (left) and an unmanned vending machine (right).

In the drawings, the following reference numbers are used: 1. Elevating system; 2. Camera; 21. Backdrop board; 22. Camera lens; 23. Camera bracket; 11. Transmission part; 12. Base; 13. Support bracket; 111. Motor; 112. Threaded rod; 113. Directional rod; 114. Transmission bracket; 115. Axial direction; 212. Cover; and 213. Hinge.

### DETAILED DESCRIPTION

To further illustrate the disclosure, embodiments detailing an image data acquisition device for an unmanned vending machine are described below. It should be noted that the following embodiments are intended to describe and not to limit the disclosure.

As shown in FIGS. 1-7, the image data acquisition device comprises a camera 2, an elevating system 1, and a control processor. The elevating system 1 is connected to the camera 2 and moves a plurality of objects in and out of a photographing scene; and the camera 2 captures an image of the plurality of objects in the photographing scene; the control processor is configured to control the elevating system 1 to move in a preset order to meet a preset placement condition, thus allowing the camera to capture an image of the plurality of objects meeting the preset placement condition; and then the control processor labels the plurality of objects in the first image through image annotation. The preset placement condition refers to a position combination of plurality of objects in the photographing scene. The elevating system 1 comprises a base 12 and a plurality of elevators; and each of the plurality of elevators comprises a transmission part 11 and a support bracket 13. The support bracket 13 is fixedly disposed on the base 12; and the transmission part 11 is fixedly disposed on the base 12 and the support bracket 13. In the example, the elevating system comprises eight elevators 1 each comprising a transmission part 11 for carrying one of the plurality of objects. The transmission part 11 comprises a motor 111, a threaded rod 112, a directional rod 113, and a transmission bracket 114. The directional rod 113 is fixedly disposed on the base 12 and the support bracket 1, and is configured to control one of the plurality of objects to move along an axial direction 115 which is an extension direction of the direction rod. The threaded rod 112 is disposed along the axial direction; one end of the threaded rod 112 is connected to the motor 111; and another end of the threaded rod 112 is fixedly connected to the support bracket 13. The transmission bracket 114 is in a threaded connection to the threaded rod 112. The transmission bracket 114 is slidably connected to the directional rod 113; and one of the plurality of objects is detachably fixed on the transmission bracket 114. As the motor 111 is energized, the threaded rod 112 rotates around the axial direction 115, causing the transmission bracket 114 to move along the axial direction 115; and one of the plurality of objects on the transmission bracket 114 moves with the transmission bracket 114. In the example, the threaded rod 112 has a diameter of 8 mm, a pitch is 2 mm, a lead of 8 mm, and an effective stroke is 300 mm. The motor is a 42BYBH39 stepper motor that comprises a TB6600 stepper motor driver and an Arduino MEGA2560R3 master control board.

The camera 2 comprises a camera lens 22, a camera bracket 23, and at least one backdrop board 21. The camera lens 22 is disposed on the camera bracket 23; and the at least one backdrop board provides a background used to take a picture. The at least one backdrop board 21 is connected to the elevating system 1, and comprises at least one through hole and at least one cover 212; the elevating system 1 drives the plurality of objects to pass through the at least one through hole. The at least one cover is disposed on the at least one through hole and is foldable relative to the at least one backdrop board 21. Specifically, the at least one backdrop board 21 further comprises a hinge 213 horizontally connected to the first at least one backdrop board 21; the at least one cover 212 is connected to the at least one backdrop board 21 through the hinge 213, and is foldable relative to the hinge 213 towards the photographing scene. In the example, the camera lens 22 is the model number G200 (1080P).

In the example, the elevating system 1 is disposed below the camera 2; the at least one backdrop board 21 is flat and level with the ground; when the plurality of objects passes through one of the plurality of through holes, the corresponding one of the plurality of covers is foldable relative to the at least one backdrop board towards the photographing scene; when the plurality of objects is moved out of the photographing scene, the at least one cover 212 falls to the at least one backdrop board 21 due to gravity, without need to any control circuits; and a maximum included angle between the at least one cover and the at least one backdrop board is not greater than 90 degree.

In an alternative preferred embodiment of the disclosure, the camera lens 22 is disposed above the photographing scene to capture a top image of the plurality of objects in the photographing scene. In an alternative preferred embodiment of the disclosure, the camera 2 further comprises a light source controlled by the control processor.

An automatic image acquisition process of beverages in the image data acquisition device of the disclosure comprises:

Several bottles of beverages are provided, placed in a grid with 3 rows and 3 columns, and fixed on eight transmission brackets 114, respectively; eight transmission brackets 114 are disposed at the top of the elevating system 1 to ensure the eight bottles of beverages are detachably fixed in the photographing scene; and the eight transmission brackets 114 is controlled by eight motors 111, respectively; the control processor controls the operation of the eight motors 111 in a preset order to ensure the eight transmission parts 11 sequentially move the eight bottles of beverages in or out of the photographing scene, respectively; and the camera 2 captures an image of a combination of the eight bottles of beverages in the photographing scene. In the example, the camera captures 2⁸=256 images of different combinations of the eight bottles of beverages. As the eight bottles of beverages are moved with the eight transmission parts 11, the control processor creates an annotation file that has information regarding type and location of each object in each first image.

An image annotation method for use in the image data acquisition device of the disclosure, the image annotation method comprising: manually labeling a first bounding box around each object in a part of first images; training a model for a one-class object detection by using the first bounding boxes; labeling a second bounding box around each object in remaining first images by using the model, thus obtaining second images; naming each object in a part of the second image according to a location of the second bounding box for each object in the part of the second images and the preset order controlled by the image data acquisition device; training a binary classification algorithm over the first bounding box and name of each object in the part of the first images, to name the second bounding boxes in remaining second images, thus creating an annotation file; and the binary classification algorithm is an object detection algorithm, such as FCOS and YOLO.

The image data acquisition device of the disclosure takes 15 minutes to place or remove the plurality of objects and collect data of 128 images, which is faster than 1.5 hours consumed by a conventional manual method. The image data acquisition device of the disclosure takes 5 minutes to manually correct the annotation file, which is faster than 45 minutes consumed by a conventional manual method.

It will be obvious to those skilled in the art that changes and modifications may be made, and therefore, the aim in the appended claims is to cover all such changes and modifications.

The invention claimed is:

1. An image data acquisition device for an unmanned vending machine, the device comprising:
a camera;
an elevating system; and
a control processor;
wherein:
the camera covers a photographing scene, and is configured to capture images of a plurality of objects in the photographing scene;
the elevating system is connected to the camera and moves the plurality of objects in and out of the photographing scene, and moves the plurality of objects in the photographing scene to meet a preset placement condition; the preset placement condition refers to a position combination of the plurality of objects in the photographing scene; and
the control processor is configured to control the elevating system to move the plurality of objects in the photographing scene in a preset order to meet the preset placement condition, to control the camera to capture an image of the plurality of objects meeting the preset placement condition, and to label the image of the plurality of objects through image annotation.

2. The device of claim 1, wherein the elevating system comprises a base and at least one elevator; and the at least one elevator comprises a transmission part and a support bracket; the support bracket is fixedly disposed on the base; and the transmission part is fixedly disposed on the base and the support bracket; the transmission part comprises a motor, a threaded rod, a directional rod, and a transmission bracket; the directional rod is fixedly disposed on the base and the support bracket, and is configured to control at least one of the plurality of objects to move along an axial direction which is an extension direction of the direction rod; the threaded rod is disposed along the axial direction; one end of the threaded rod is connected to the motor; and another end of the threaded rod is fixedly connected to the support bracket; the transmission bracket is in a threaded connection to the threaded rod; the transmission bracket is slidably connected to the directional rod; and the plurality of objects is detachably fixed on the transmission bracket.

3. The device of claim 2, wherein the elevating system comprises a plurality of elevators each comprising the transmission part for carrying one of the plurality of objects.

4. The device of claim 3, wherein the camera comprises a camera lens, a camera bracket, and at least one backdrop board; the camera lens is disposed on the camera bracket; the at least one backdrop board provides a background used to take a picture and is at least one in number; the at least one backdrop board is connected to the elevating system and comprises at least one through hole; and the elevating system drives the object to pass through the at least one through hole.

5. The device of claim 4, wherein the at least one backdrop board comprises at least one cover.

6. The device of claim 5, wherein the at least one backdrop board further comprises a hinge horizontally connected to the at least one backdrop board; the at least one cover is connected to the at least one backdrop board through the hinge, and is foldable relative to the at least one backdrop board towards the photographing scene.

7. The device of claim 6, wherein when in an unfolded state of the at least one cover, a maximum included angle between the at least one backdrop board and the at least one cover is not greater than 90 degrees.

8. The device of claim 4, wherein the camera lens is disposed above the photographing scene to capture a top image of the objects in the photographing scene.

9. The device of claim 4, wherein the camera further comprises a light source controlled by the control processor.

10. An image annotation method for use in the image data acquisition device of claim 1, the method comprising:
manually labeling a first bounding box around each object in a part of first images;
training a model for a one-class object detection by using the first bounding box around each object in the number of the first images, to label a second bounding box around each object in remaining first images;
labeling the second bounding box around each object in the remaining first images by using the model, thus obtaining second images;
naming each object in a part of the second images according to a location of the second bounding box for each object in the part of the second image and the preset order controlled by the image data acquisition device; and
training a binary classification algorithm over the first bounding box and name of each object in the part of the first images, to name the second bounding boxes in the remaining second images, thus creating an annotation file.
